(19) United States
(12) Patent Application Publication
(10) Pub. No.: US 2017/0236256 A1
(43) Pub. Date: Aug. 17, 2017

(54) SYSTEM AND METHOD FOR ISOLATING BEST DIGITAL IMAGE WHEN USING DECONVOLUTION TO REMOVE CAMERA OR SCENE MOTION

(71) Applicant: XSight Technologies LLC, Calabasas, CA (US)

(72) Inventors: Stephane Bucaille, Calabasas, CA (US); Mark Davis, Port Orange, FL (US)

(21) Appl. No.: 15/430,228

(22) Filed: Feb. 10, 2017

Related U.S. Application Data
(60) Provisional application No. 62/294,202, filed on Feb. 11, 2016.

(51) Int. Cl. G06T 5/00; G06T 3/40; H04N 5/232; G06T 7/00

(52) U.S. Cl. CPC G06T 5/003; G06T 7/0002; G06T 3/40; H04N 5/23267; G06T 2207/10004; G06T 2207/20201

(57) ABSTRACT

A computer-implemented method and system of imaging processing for correcting an image may include determining an initial score of the image in response to receiving an image captured by an electronic device. Input parameters for performing deconvolution of the image may be initiated. The image may be deblurred utilizing deconvolution as a function of the input parameters. A score of the image may be determined. A determination as to whether the score of the image meets at least one criteria indicative of whether an optimal image has been determined may be made. If an optimal image has been determined, the image and image parameters utilized to determine the optimal image may be output. Otherwise, the input parameters may be adjusted. The deblurring, determining, determining, and adjusting may be repeated until the optimal image has been determined.

### RELATED APPLICATIONS

This application claims priority to co-pending U.S. Provisional Patent Application Ser. No. 62/294,202 filed Feb. 11, 2016; the contents of which are hereby incorporate herein by reference in their entirety.

### BACKGROUND OF THE INVENTION

Blurry digital images are a chronic problem for both amateur and professional photographers alike. The number of digital images, which include both static images and video, being taken on small, lightweight, high-resolution devices (e.g., mobile telephones) has increased dramatically over the years. With this increase in digital images, the number of blurry images has also increased at least in part due to the lightweight devices being unsteady due to shaky hands or other reasons and having little, if any, compensation for the unsteady nature of imaging from the lightweight devices

With the increase of captured images, which is nothing short of incomprehensively massive, comes an equally high level of storage capacity needs for storing the digital images. As understood, mass storage of digital images is expensive and requires a significant amount of equipment and power to maintain and cool the equipment used to store the digital images. For the electronic devices that capture the images, images may consume a lot of memory and be slow in processing the images. For local computing equipment, such as desktop, laptop, or tablet devices, for example, processing and storing the images can be memory and processing intensive.

Moreover, as a result of the blurred images, users to capture the images often want to correct for the blurriness in the images. Algorithms, software and processes exist which help correct blurred images, but have shortcomings. As an example, current software techniques for correcting blurred images rely heavily on a highly educated/technical user to manually select appropriate technical values, which, when fed into various software algorithms, output the clearest, sharpest image. In most existing processes used to solve for image quality, there are several input parameters needed to be input by a user who understand the effects of changing each of the image processing. As a basic rule, most users who are not image processing savvy, such image processing is not possible to use effectively because the processes are highly manual. As an example, if optimal input parameters are not used, the color red may result in being “muddy.” Also, as sharpening is performed, pixilation and a white hollow effect results around edges of image features (e.g., hair and trees).

The technical process of deblurring or sharpening an image is commonly referred to as image deconvolution. Furthermore, the removal of a blur where there is no sensor data or known blur kernel is generally referred to as blind image deconvolution. Blind image deconvolution has been extensively studied and has significant history within image and signal processing research.

As the process of image deconvolution is reasonably understood, the long history of the research has left a number of software and algorithmic fine tuning to the user. This fine tuning leaves significant margins of error and potential correctable defects within an image and may require significant understanding of and user interaction with the underlying mathematics and algorithms to obtain the best result (e.g., the sharpest or least blurry image).

Moreover, and as well known, the cost for maintaining, cooling, and powering the servers are high. As images are stored in the servers due to consumer and commercial usage, each of the cost issues becomes large. Hence, there is a need to not only to improve the ability and time it takes to produce high-quality images, but also reduce the costs by reducing the size of the stored images.

### SUMMARY OF THE INVENTION

A computerized method and system is provided to optimally isolate and select an output image for clarity and sharpness based upon a deconvolved image using a blur kernel. As provided herein, a system and computerized process for determining a best image may be performed by calculating optimal input parameters used for performing image processing (or other signal processing on non-image data). A computerized method of deblurring the image may employ the Fergus deblurring technique (see U.S. Pat. No. 7,616,826), and further refine an image by manipulating input parameters to Fergus and repeatedly test the output to isolate the clearest image.

One embodiment provides for a technique and process for removing complexity of a known image deconvolution techniques so as to isolate an optimal output from an image or signal processing algorithm with minimal or no input from a user.

One embodiment of a computer-implemented method of imaging processing for correcting an image may include determining an initial score of the image in response to receiving an image captured by an electronic device. Input parameters for performing deconvolution of the image may be initiated. The image may be deblurred utilizing deconvolution as a function of the input parameters. A score of the image may be determined. A determination as to whether the score of the image meets at least one criteria indicative of whether an optimal image has been determined may be made. If an optimal image has been determined, the image and image parameters utilized to determine the optimal image may be output. Otherwise, the input parameters may be adjusted. The deblurring, determining, determining, and adjusting may be repeated until the optimal image has been determined.

An embodiment of a system for image processing to correct an image may include a memory configured to store image data, an input/output (I/O) unit configured to communicate data over a communications network, and a processing unit in communication with the memory and I/O unit, and configured to determine an initial score of the image in response to receiving an image captured by an electronic device. Input parameters may be initiated for performing deconvolution of the image. The image may be deblurred utilizing deconvolution as a function of the input parameters. A score of the image may be determined. A determination as to whether the score of the image meets at least one criteria indicative of whether an optimal image has been determined. If an optimal image has been determined, the image and image parameters utilized to determine the optimal image may be output. Otherwise, the input parameters may be adjusted. The deblurring, determining, determining, and adjusting may be repeated until the optimal image has been determined.

### BRIEF DESCRIPTION OF THE DRAWINGS

Illustrative embodiments of the present invention are described in detail below with reference to the attached drawing figures, which are incorporated by reference herein.

FIG. 1 is a block diagram of an illustrative network environment in which electronic devices, such as mobile smartphones, are used to capture images and communicate with back-end servers for storage and/or editing of the images;

FIG. 2 is a flow diagram of an illustrative process for performing dynamic image deconvolution with minimal user interaction;

FIG. 3 depicts the basic function of image size to image quality based upon the input variables, primarily lambda;

FIG. 4 is a graph that depicts a Gaussian model that is reflective of the function of lambda on the image quality;

FIGS. 5A-5C are a set of illustrative photographs showing (i) a captured photograph, (ii) photograph having been processed using existing imaging processing, and (iii) photograph having been processes using the image processing described herein; and

FIGS. 6A-6C are another set of illustrative photographs showing (i) a captured photograph, (ii) photograph having been processed using existing imaging processing, and (iii) photograph having been processes using the image processing described herein.

### DETAILED DESCRIPTION OF THE INVENTION

The present invention introduces a new technique and process for removing the complexity of a known image deconvolution technique so as to isolate the best output from the algorithm with minimal input from a user.

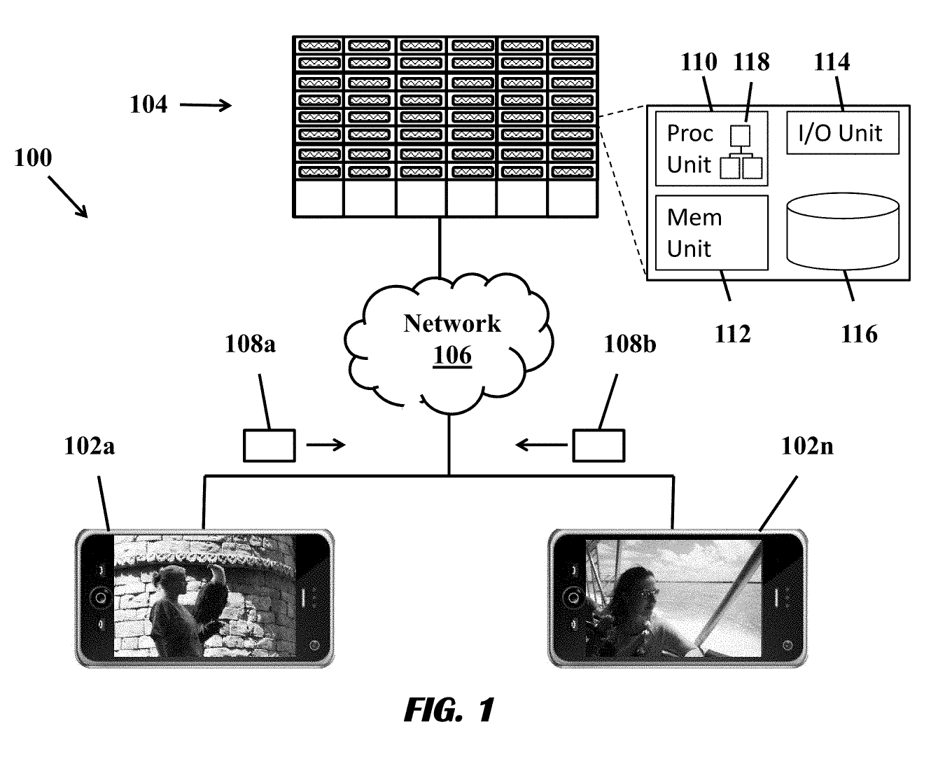

With reference to FIG. 1, an illustration of a network environment 100 in which electronic devices 102a-102n (collectively 102), such as mobile smartphones, are used to capture images 104a-104n (collectively 104) and communicate with back-end servers 104 for storage and/or editing of the images via a network 106 is shown. The images 102 may be communicated via data messages 108a-108n (collectively 108). In one embodiment, rather than the user using the back-end servers 104 for editing, the electronic devices 102 may be configured to edit the images, as further described herein. The servers 104 may be part of a server farm that is used to store data, such as images, and/or provide for user applications, such as social media, search functions, data storage, or any other application, as understood in the art. In one embodiment, one or more of the servers 104 may be configured with the computer-implemented processes further described herein for editing and reducing the size of photos in an optimal manner.

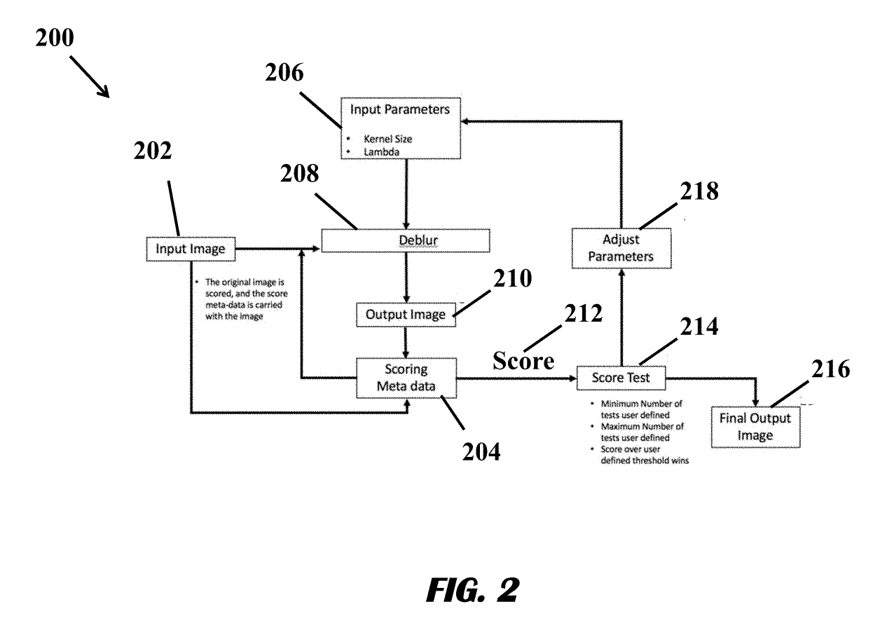

Each of the servers 104 may include a processing unit 110, memory unit 112 configured to store image data, input/output (I/O) unit 114 configured to communicate over the communications network 106, and storage unit 116 including one or more data repositories 118 for storing original and optimized images. The processing unit 110 may include one or more computer processors in communication with the memory unit 112 and I/O unit 114. The processing unit 110 may be configured to execute software 118 that performs the image processing, as further described with regard to FIG. 2. Moreover, the electronic devices 102 may also include electronics

It is contemplated that three or more processing techniques may be utilized. In one embodiment, an electronic device 102a may communicate an image to the servers 104 for performing image processing in the “cloud,” and a corrected image may be communicated back to the electronic device. In another embodiment, an electronic device 102a may communicate an image to the servers 104 for performing image processing, and image correction parameters may be communicated back for an app to adjust the image based on the received image correction parameters. In yet another embodiment, rather than the electronic device 102a communicating an image to the servers 104, the electronic device 102 a may perform the image processing itself. It should be understood, however, that the image processing is processing and memory intensive, but as processing and memory capacity on electronic devices is increased, the processing may be performed locally. Still yet, one or more servers may be configured to perform the image processing from cloud-based storage systems.

With reference to FIG. 2, an illustrative process 200 for automatically determining an optimal digital image is detailed. In additional to providing for an automated process for determining an optimal digital image, the process 200 provides for eliminating or minimizing artifacts caused by image processing processes, such as sharpening. The optimal digital image may mean a digital image having a highest quality based sharpness, spectrum or color density, blurriness, pixilation, edge ringing, lowest memory size, or other image quality parameter. As understood in the art, image quality parameters often provide for tradeoffs that provide for a compromise between highest achievable value of one parameter with less than highest achievable value of another parameter, but that overall objectives are met. In some cases, none of the parameters are highest achievable value, but overall objectives are met. For example, a high value of sharpness of an image may be less than the highest achievable value, but the memory size of the image is significantly lower than if the image had a higher sharpness value. In one embodiment, the process 200 provides for a multi-variable solution that uses sharpness and spectrum (color density, such as white), for example, for adjusting and/or determining a best or highest quality image.

The process 200 may start by receiving an input digital image 202. An initial reference score may be determined from an analysis of the digital image 202, prior to performing any image processing on the digital image 202. The score may be determined by calculating various image parameters, such as sharpness, image clarity/edge ringing, color density or spectrum (white), and/or other image parameters, prior to performing any image processing so that an initial reference score of the digital image 202 may be utilized for comparison purposes during the process 200.

Input parameters 206, including but not limited to lambda and kernel size, may be set as constant defaults, as follows:

lambda=100

kernel size=31

The initial values of lambda and kernel size are illustrative, and is should be understood that the default values may be set to other values. The lambda and kernel size parameters are adjusted to determine an optimal image quality by the process 200.

Kernel size represents a size of a filter that is used to remove motion in an image. As an analogy, kernel size can be compared to a sponge size that is used for washing an object, such as a vehicle, where on sponge size works best for certain objects, while other sponge sizes work better for different objects. Utilizing the principles described herein, kernel size may be varied a certain number of times, such as 7 times, to determine a kernel size that provides for an optimal corrected image (e.g., sharpened and color density). It should be understood that a different number of kernel sizes may be utilized. However, the higher the number of kernel sizes, the more time and memory utilized, but the lower number of kernel sizes, the less optimal the correcting of the image. A change of kernel size 7 times has been found to be a good balance of speed and quality.

As understood in the art, there are 40 different input parameters. However, it has been determined by performing thousands of tests that three of the input parameters, including kernel size, gamma, and lambda may be used to control image correction and image memory size, as further described herein.

At step 208, a deblurring image processing process may be performed based upon the digital image 202 and the input parameters 206. In one embodiment, the deblurring image processing process may utilize a deconvolution process described in U.S. Pat. No. 7,616,826, the contents of which are hereby incorporated by reference in their entirety, and may generate an output image 210. As has been observed, the deblurring process 208 provided by U.S. Pat. No. 7,616,826 requires a highly trained user to operate, and the deblurring process 208 creates image artifacts (e.g., white scintillations and white halo effects). Those image artifacts may be removed or eliminated by the use of the automated feedback for adjusting the input parameters to be used by the deblurring process, as described herein.

The blurring process 208 tends to degrade the quality of color distribution, particularly affecting (small) red areas on images. As has been observed, red is barely adjusted or even improved by the process provided in FIG. 2, whereas small red features tend to completely disappear using the blurring process 208, as provided in U.S. Pat. No. 7,616,826, as a stand-alone process.

As has been observed, processing time utilizing the process 200 consistently is reduced from tens of minutes to hundreds of milliseconds. In addition, file size of the images are generally reduced by over 60% from the original memory size to the memory size after being processed by the process 200. It should be understood that other percentages, such as 20% or higher, may be sufficient enough to employ the image processing described herein.

Other deconvolution processes may be utilized, but the one provided in 7,616,826 provides for utilizing the automated feedback image processing process shown in FIG. 2.

The output image 210 may be scored at step 204 to produce a score 212 on a scale of 0 to 100 utilizing an algorithm (see equations below) to determine edge density and image intensity. The scoring at step 204 may compute an optimal image quality score representative of the quality of the output image 210. In an alternative embodiment, the scoring may be performed as part of the deblurring process 208. In one embodiment, the scoring may generate a score limited to quality. In an alternative embodiment, the scoring at step 204 may generate a score that factors in size of the output image 210. The score 212 (metadata associated with the output image 210) may be determined by summing edge density and image intensity after applying constant weights for the output image 210. This score 212 is then provided with the output image 210 to step 214 to perform a score test. Additional scoring techniques may be added to include image sharpness, clarity, edge ringing, noise, and color density per channel.

As the sharpening filter is further refined by adjusting the lambda and kernel size values, using a Monte Carlo approach, the image enhancement is optimized until a point where the image quality quickly degrades is reached. This “tipping point” or degradation point represents an optimal enhancement for a given image. As the image quality quickly deteriorates, multiple white edges appear in symmetric and periodic patterns, which considerably changes the color density of the image, as well. Hence, an automated process may be utilized to identify the degradation point, thereby optimizing an image quality and memory size. The optimized image may or may not be at the degradation point, but the degradation point provides for an identifiable boundary.

The edge detection may be completed using any competent edge detection algorithm that minimizes noise and false positives. In one embodiment, a Canny Edge Detection with a sigma between 0.6 and 1.4 may be utilized to summarize the number of edges while limiting false positives. See, for example,

http://citeseerx.ist.psu.edu/viewdoc/download?doi=10.1.1.420.3300&rep=rep1&type=pdf

Additionally, an overall image intensity may be calculated. Commonly, intensity is calculated using an average of the RGB pixel value. However, it has been noticed that for pixels with a more dominant blue value in the RGB color space that more accuracy is provided when a luminosity is calculated instead of the average.

Luminosity may be calculated by:

Pixel Luminosity=((Red*0.2125)+(Green*0.7154)+(Blue*0.0721))

The pixel intensity may be summed to provide an overall image intensity and added to the metadata for the image.

As image intensity and number of edges increase, the image is degraded. To calculate the image score, the image intensity and edge count may be utilized, as follows:

Assume:

Original Image Edge Density=Oₑ

Original Image Intensity=Oᵢ

Edge Density=E

Intensity=I

$$Edge Factor \text{:} {E}_{f} = \frac{E}{{O}_{e}}$$

$$Intensity Factor \text{:} {I}_{f} = \frac{I}{{O}_{i}}$$

Score: S=100(1−(|(1−E_{f})|(0.35)+|(1−l_{f})|(0.65))

Continuing at step 214, the score 212 may then compared to prior scores and to a user defined threshold. If the score 212 meets or exceeds the user defined threshold, then the score 212 is considered passed such that the process 200 continues at step 216, where a final output image is produced. If the score 212 is lower than the threshold, then throughout a user defined number of maximum attempts, the process 200 may continue at step 218 to automatically adjust the input parameters 206. If the maximum number of attempts is reached, the highest scored image regardless of the threshold setting is sent to step 216.

The feedback loop including input parameters 206, deblurring process 208, output image 210, scoring function 204, scoring test 214, and parameter adjustment step 218 may be performed to optimize image quality parameters while simultaneously producing the smallest memory sized image.

Based upon prior input parameters, a new set of input parameters may be calculated, as follows:

To calculate the new lambda value, the following process may be utilized, where:

Cn=number of scores that have been completed

Avg=Average of prior scores

Stdv=Standard deviation of prior scores

Score=Current score (see score S above)

lambda=last lambda used

If the count is >1 and score<prior score

New lambda=lambda+stdv

In all other cases, new lambda=lambda−stdv.

Additionally, based upon testing, lambda should be clamped to values between 60 and 3,000, although it is contemplate that certain situations may result in different ranges of lambda.

Once an image has passed scoring, a final deblurred image is generated and output at step 216.

In processing an image, three primary attributes may be varied, including kernel size, gamma, and lambda. Adjustments of values of these three primary attributes may affect an image output in various ways. For example, kernel size and lambda may both affect and adjust blurriness or sharpness of an image, and gamma affects image intensity, white balance, and may affect edge detection. Combined these three attributes may have profound impacts on the image output through either the removal of artifacts or through adding unintentional artifacts into the image. The reduction of artifacts, in general, provides reduced image size and increased image sharpness, whereas, in general, the opposite is true when artifacts are introduced (i.e., the image may increase in size and may have a less than visually optimal result when viewed by a person. While trained human image editors can utilize an image editing tool proficiently, such as described in U.S. Pat. No. 7,616,826, the automated process of varying the three primary attribute values described herein makes image editing possible for software automation that provides for high performance and may be used by untrained individuals, such as ordinary mobile phone users.

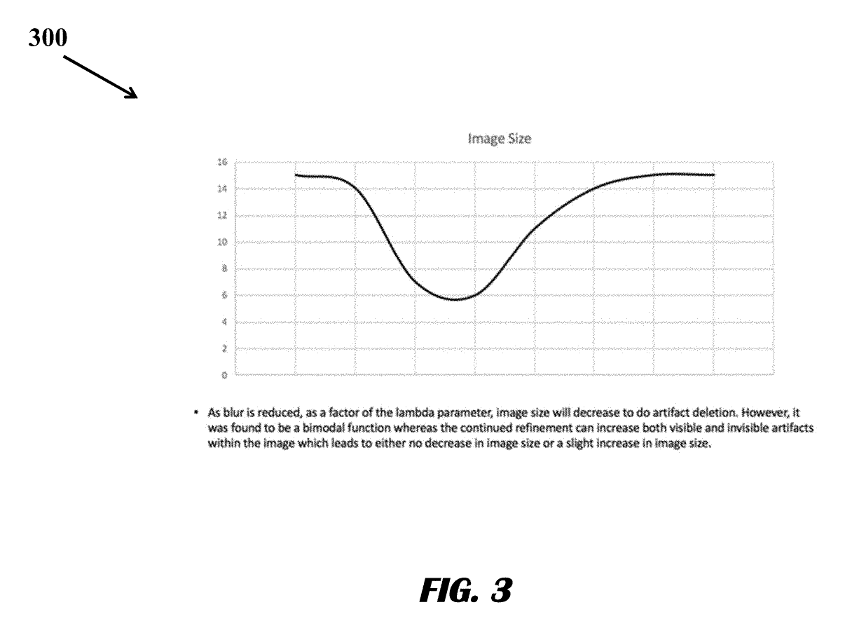

FIG. 3 is a graph 300 of an illustrative curve 302 that depicts the basic function of image size to image quality based upon the input variables, primarily Lambda. The graph 300 is reflective of an image where when lambda is optimized, the physical data size of an image may be reduced by up to 66 %. This is primarily due to artifact deletion within the image, both visible and invisible. Artifact may be considered data extracted from analysis of a picture. It was found through testing, however, that the image size as it relates to image quality and lambda is a bi-modal function and may actually increase if lambda is not optimized. This increase of image size is due to algorithmic artifacts being introduced into the image.

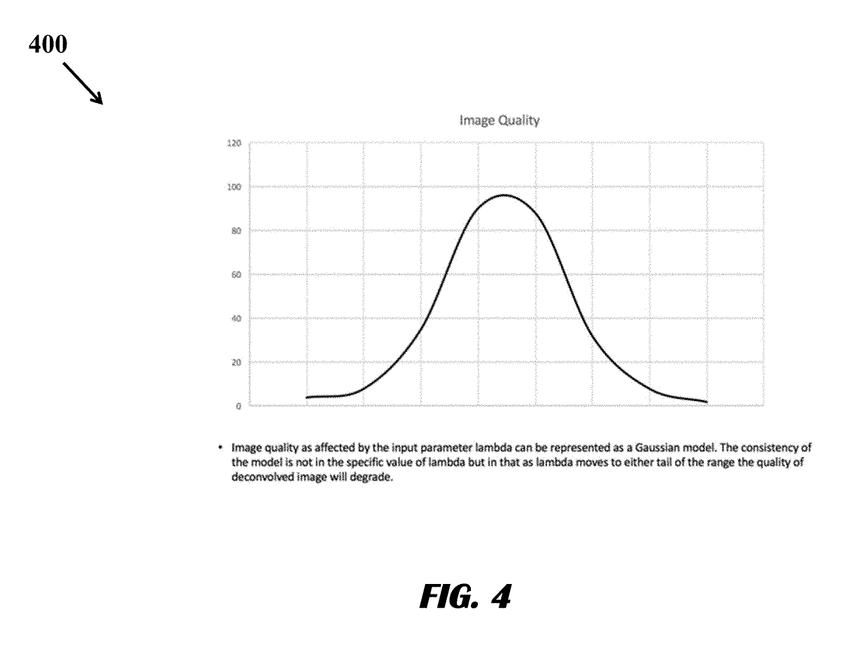

FIG. 4 depicts a Gaussian model that is reflective of the function of lambda on the image quality. Each image has a unique peak value for lambda, and at either end from the lambda with the unique peak value, the image quality is degraded significantly. Further, through testing, it was found that most images have a reasonable image quality increase when lambda is started between 100-200. Hence, the process 200 of FIG. 2 may set lambda in a range between 100 and 200 as a default to reduce processing time in determining an optimal image quality solution.

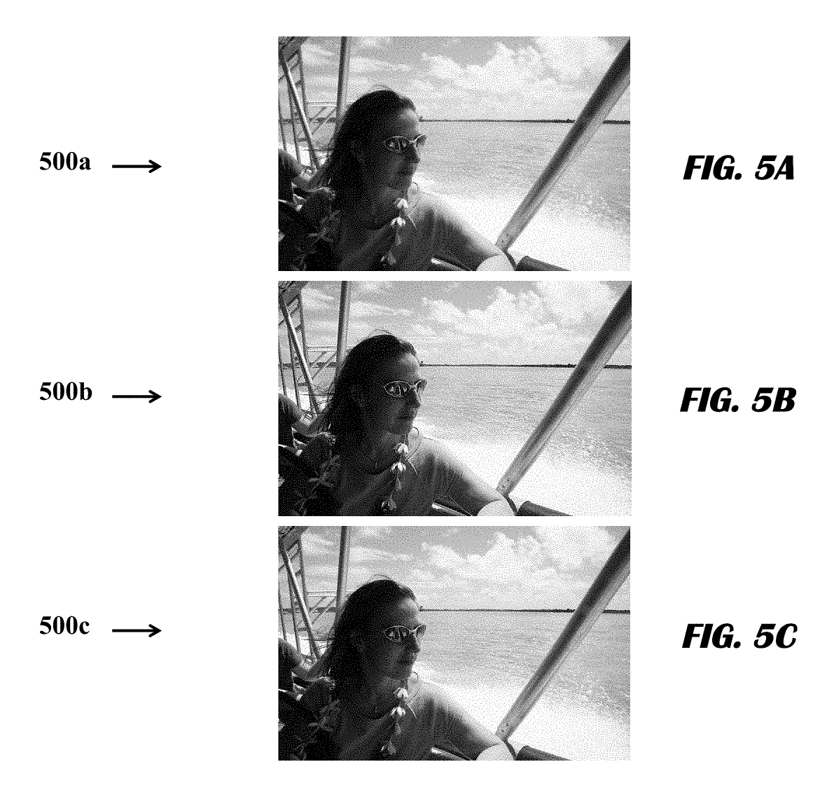

With reference to FIGS. 5A-5C, a set of illustrative photographs showing (i) a captured photograph 500a, (ii) photograph 500b having been processed using existing imaging processing, and (iii) photograph 500c having been processes using the image processing described herein are shown. In particular, it can be seen that the captured photograph 500a is blurry and lacks clarity. As previously described, the use of handheld imaging devices, such as mobile telephones with relatively slow shutter speeds, causes motion and blurriness in the photograph, which results in a user wanting to improve the sharpness of the photograph 500a. However, as well understood, as a digital photograph is sharpened, artifacts, such as white regions at object edges, are formed. Photograph 500b was produced using the deblurring image processing provided in the U.S. Pat. No. 7,616,826. In producing the photograph 500b, manual efforts were performed, which took about 30 minutes. As shown, the photograph 500b has been sharpened, but a white line is shown to have resulted along the underside of the arm of the girl in the photograph 500b. Photograph 500c was produced in an automated manner and in less than 1 second utilizing the process 200 of FIG. 2. The photograph 500c shown has the same or improved sharpness over photograph 500b and no longer includes or have a minimal amount of the line along the underside of the arm of the girl in the photograph 500b. Other artifacts shown in the photograph 500b are eliminated in photograph 500c.

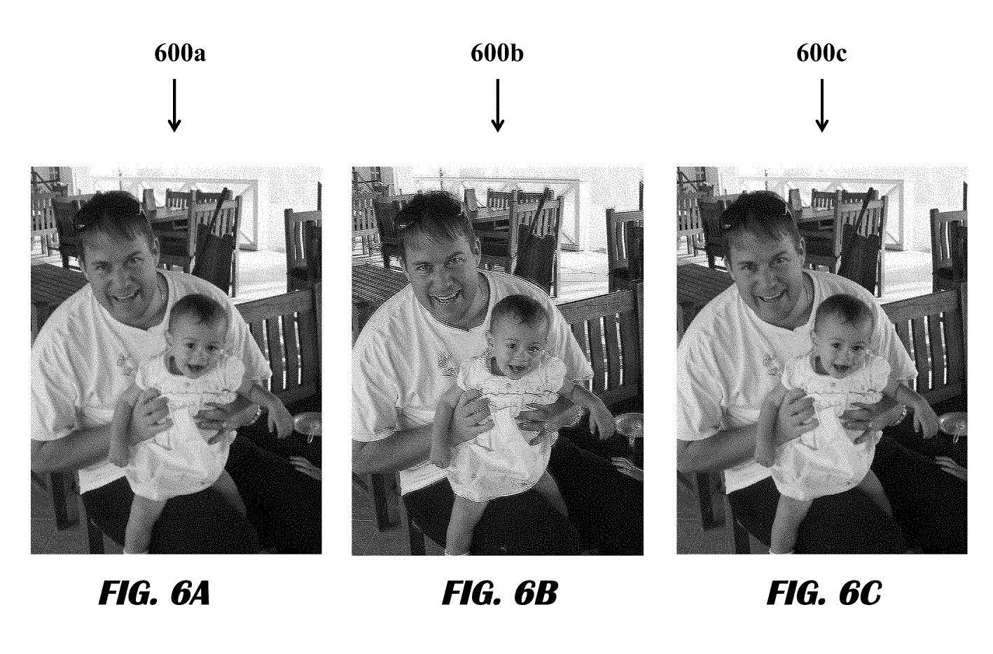

FIGS. 6A-6C are another set of illustrative photographs showing (i) a captured photograph 600a, (ii) photograph 600b having been processed using existing imaging processing, and (iii) photograph 600c having been processes using the image processing described herein. Similar to FIG. 5A, the photograph 600a includes blurriness due to slight motion from the use of a handheld camera. FIG. 6B shows a photograph 600b that was overcorrected by applying too much sharpening using the deblurring image processing provided in the U.S. Pat. No. 7,616,826. Again, the deblurring image processing to produce the photograph 600b is performed by a skilled user with knowledge of the deblurring process. As shown, there are white streaks throughout the photograph 600b due to over sharpening. And, because the deblurring image processing is manually performed, it is difficult and time consuming to determine an optimal image through adjustment of input parameters (e.g., lambda and kernel size). FIG. 6C is a photograph showing an optimal image as a result of the automated process of FIG. 2 that results in a corrected photograph 600c that has no or minimal artifacts by determining optimal input parameters for correcting the photograph 600a.

The image processing described herein may be utilized in a fully automated manner. The image processing may be performed on a variety of different images, including non-professional images captured by users of mobile or other electronic devices, professional images captured by a variety of electronic devices, videos collected by amateur or professional videographers. Still yet, machine captured images, such as medical images, may be processed utilizing the processes described herein. Such images are memory intensive, and the use of the process described herein may improve the image quality for medical professionals while reducing memory usage of the images.

Definitions and methods described herein are provided to better define the present disclosure and to guide those of ordinary skill in the art in the practice of the present disclosure. Unless otherwise noted, terms are to be understood according to conventional usage by those of ordinary skill in the relevant art.

In some embodiments, numbers expressing quantities of ingredients, properties such as molecular weight, reaction conditions, and so forth, used to describe and claim certain embodiments of the present disclosure are to be understood as being modified in some instances by the term “about.” In some embodiments, the term “about” is used to indicate that a value includes the standard deviation of the mean for the device or method being employed to determine the value. In some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the present disclosure are approximations, the numerical values set forth in the specific examples are reported as precisely as practicable. The numerical values presented in some embodiments of the present disclosure may contain certain errors necessarily resulting from the standard deviation found in their respective testing measurements. The recitation of ranges of values herein is merely intended to serve as a shorthand method of referring individually to each separate value falling within the range. Unless otherwise indicated herein, each individual value is incorporated into the specification as if it were individually recited herein.

In some embodiments, the terms “a” and “an” and “the” and similar references used in the context of describing a particular embodiment (especially in the context of certain of the following claims) can be construed to cover both the singular and the plural, unless specifically noted otherwise. In some embodiments, the term “or” as used herein, including the claims, is used to mean “and/or” unless explicitly indicated to refer to alternatives only or the alternatives are mutually exclusive.

The terms “comprise,” “have” and “include” are open-ended linking verbs. Any forms or tenses of one or more of these verbs, such as “comprises,” “comprising,” “has,” “having,” “includes” and “including,” are also open-ended. For example, any method that “comprises,” “has” or “includes” one or more steps is not limited to possessing only those one or more steps and can also cover other unlisted steps. Similarly, any composition or device that “comprises,” “has” or “includes” one or more features is not limited to possessing only those one or more features and can cover other unlisted features.

The foregoing method descriptions and flow diagrams are provided merely as illustrative examples and are not intended to require or imply that the steps of the various embodiments must be performed in the order presented. The steps in the foregoing embodiments may be performed in any order. Words such as “then,” “next,” etc., are not intended to limit the order of the steps; these words are simply used to guide the reader through the description of the methods. Although process flow diagrams may describe the operations as a sequential process, many of the operations can be performed in parallel or concurrently. In addition, the order of the operations may be rearranged. A process may correspond to a method, a function, a procedure, a subroutine, a subprogram, etc. When a process corresponds to a function, its termination may correspond to a return of the function to the calling function or the main function.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or the like, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory, processor-readable storage media may be any available media that may be accessed by a computer. By way of example, and not limitation, such non-transitory, processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory, processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed:

1. A computer-implemented method of imaging processing for correcting an image, said method comprising:
in response to receiving an image captured by an electronic device, determining an initial score of the image;
initiating input parameters for performing deconvolution of the image;
deblurring the image utilizing deconvolution as a function of the input parameters;
determining a score of the image;
determining whether the score of the image meets at least one criteria indicative of whether an optimal image has been determined;
if an optimal image has been determined, outputting the image and image parameters utilized to determine the optimal image;
otherwise, adjusting the input parameters; and
repeating deblurring, determining, determining, and adjusting until the optimal image has been determined.

2. The method according to claim 1, wherein determining a score of the image includes determining a value for image clarity.

3. The method according to claim 1, wherein receiving an image captured by an electronic device includes receiving an image captured by a mobile telephone.

4. The method according to claim 1, wherein adjusting the input parameters including adjusting the input parameters using a Monte Carlo process.

5. The method according to claim 1, further comprising communicating final input parameters to an electronic device from which the image was received.

6. The method according to claim 1, further comprising communicating the optimal image to an electronic device from which the image was received.

7. The method according to claim 1, wherein the processing is performed on an electronic device inclusive of a camera that captured the image.

8. The method according to claim 1, wherein adjusting the input parameters includes adjusting kernel size.

9. The method according to claim 8, wherein adjusting kernel size includes altering the kernel size 7 times.

10. The method according to claim 1, wherein image size of the optimal image is reduced by over about 60% from an original image size.

11. A system for image processing to correct an image, said system comprising:
a memory configured to store image data;
an input/output (I/O) unit configured to communicate data over a communications network;
a processing unit in communication with said memory and I/O unit, and configured to:
in response to receiving an image captured by an electronic device, determine an initial score of the image;
initiate input parameters for performing deconvolution of the image;
deblur the image utilizing deconvolution as a function of the input parameters;
determine a score of the image;
determine whether the score of the image meets at least one criteria indicative of whether an optimal image has been determined;
if an optimal image has been determined, output the image and image parameters utilized to determine the optimal image;
otherwise, adjust the input parameters; and
repeat deblurring, determining, determining, and adjusting until the optimal image has been determined.

12. The system according to claim 11, wherein said processing unit, in determining a score of the image, is further configured to determine a value for image clarity.

13. The system according to claim 11, wherein said processing unit, in receiving an image captured by an electronic device, is further configured to receive an image captured by a mobile telephone.

14. The system according to claim 11, wherein said processing unit, in adjusting the input parameters, is further configured to adjust the input parameters using a Monte Carlo process.

15. The system according to claim 11, wherein said processing unit, in communicating final input parameters to an electronic device from which the image was received.

16. The system according to claim 11, further comprising communicating the optimal image to an electronic device from which the image was received.

17. The system according to claim 11, wherein the processing is performed on an electronic device inclusive of a camera that captured the image.

18. The system according to claim 11, wherein adjusting the input parameters includes adjusting kernel size.

19. The system according to claim 18, wherein adjusting kernel size includes altering the kernel size 7 times.

20. The system according to claim 11, wherein said processing unit is further configured to reduce image size of the image by over 60% from an original image size.
